(19) United States
(12) Patent Application Publication
(10) Pub. No.: US 2026/0070809 A1
(43) Pub. Date: Mar. 12, 2026

(54) POSITIVE ELECTRODE ACTIVE MATERIAL PRECURSOR FOR LITHIUM-ION SECONDARY BATTERY AND METHOD FOR PRODUCING POSITIVE ELECTRODE ACTIVE MATERIAL PRECURSOR FOR LITHIUM-ION SECONDARY BATTERY

(71) Applicants: Kansai Catalyst Co., Ltd., Osaka (JP); HONDA MOTOR CO., LTD., Tokyo (JP); FORMOSA JAPAN Co., Ltd., Tokyo (JP)

(72) Inventors: Koichi HASHIMOTO, Osaka (JP); Kazumasa SAKATSUME, Saitama (JP); Yoshiyuki MORITA, Saitama (JP); Akihisa TANAKA, Saitama (JP); Kazuki CHIBA, Saitama (JP); Takashi HAKARI, Saitama (JP); Toshiyuki TODA, Tokyo (JP)

(21) Appl. No.: 19/324,736

(22) Filed: Sep. 10, 2025

(30) Foreign Application Priority Data
Sep. 12, 2024 (JP) 2024-158185

(51) Int. Cl. C01G 53/506

(52) U.S. Cl. CPC C01G 53/506; C01P 2002/72; C01P 2002/85; C01P 2004/03; C01P 2004/61; C01P 2004/84; C01P 2006/11; C01P 2006/12; C01P 2006/40

(57) ABSTRACT

A positive electrode active material precursor for a lithium-ion secondary battery, containing a metal composite hydroxide, wherein
the metal composite hydroxide is in a form of a particle having a core-shell structure whose surface is coated with an iron compound,
the core-shell structure is constituted by a core portion and a shell portion,
the core portion contains nickel and aluminum as metal elements,
the shell portion contains iron as a metal element,
when a composition of the core portion is represented by Ni₍₁₋ₓ₎Alₓ(OH)₂,
0.01≤x≤0.2 is satisfied,
and
a molar ratio (M₂/M₁) between a molar amount M₁ of the metal element in the core portion and a molar amount M₂ of the metal element in the shell portion satisfies

$${M}_{2} / {M}_{1} = 1 / 100 to 1 / 5.$$

### BACKGROUND

### Technical Field

The present invention relates to a positive electrode active material precursor for a lithium-ion secondary battery and a method for producing a positive electrode active material precursor for a lithium-ion secondary battery.

### Related Art

In recent years, research and development on a secondary battery that contributes to improvement of energy efficiency have been conducted. In particular, a lithium-ion secondary battery is becoming increasingly important as a power source for an electric vehicle (EV), a hybrid electric vehicle (HEV), or the like.

A positive electrode active material precursor has attracted attention as an important component for determining a capacity of a lithium-ion secondary battery, and development thereof has been advanced. As a positive electrode active material precursor used for a lithium-ion secondary battery, a material based on cobalt has been conventionally used.

However, a material based on cobalt is expensive and has been pointed out to be a resource risk. Therefore, development of a material based on an element instead of cobalt is required. For example, Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020 reports, as a cobalt-free material, a positive electrode active material precursor in which nickel, iron, and aluminum are converted into a hydroxide by a coprecipitation process.

### CITATION LIST

### Non Patent Literature

Non Patent Literature 1: Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020

### SUMMARY

Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020 reports that a lithium-ion secondary battery prepared using a positive electrode active material precursor has achieved a high capacity of 190 mAh/g at a rate of 0.1 C.

However, there is still room for improvement in a capacity of the lithium-ion secondary battery.

The present invention has been made to solve the above problems, and an object of the present invention is to provide a cobalt-free positive electrode active material precursor for a lithium-ion secondary battery, from which a lithium-ion secondary battery capable of further increasing a discharge capacity can be obtained, and a method for producing the positive electrode active material for a lithium-ion secondary battery. This ultimately contributes to improvement of energy efficiency.

In order to achieve the above object, the present invention provides the following configurations.
[1] A positive electrode active material precursor for a lithium-ion secondary battery, containing a metal composite hydroxide, wherein
   the metal composite hydroxide is in a form of a particle having a core-shell structure whose surface is coated with an iron compound,
   the core-shell structure is constituted by a core portion and a shell portion,
   the core portion contains nickel and aluminum as metal elements,
   the shell portion contains iron as a metal element,
   when a composition of the core portion is represented by Ni₍₁₋ₓ₎Alₓ(OH)₂,
   0.01≤x≤0.2 is satisfied,
   and
   a molar ratio (M₂/M₁) between a molar amount M₁ of the metal element in the core portion and a molar amount M₂ of the metal element in the shell portion satisfies

$${M}_{2} / {M}_{1} = 1 / 100 to 1 / 5.$$

A surface of the positive electrode active material precursor for a lithium-ion secondary battery (hereinafter, also simply referred to as a “precursor”) according to [1] is coated with an iron compound. Therefore, a surface of a positive electrode active material for a lithium-ion secondary battery (hereinafter, also simply referred to as a “positive electrode active material”) obtained by firing the precursor can be suppressed from being rich in aluminum. Therefore, a discharge capacity of a lithium-ion secondary battery (hereinafter, also simply referred to as a “secondary battery”) using the positive electrode active material can be further increased. Therefore, in the secondary battery, it is possible to reduce the number of batteries required and contribute to cost reduction. That is, it is possible to contribute to improvement of energy efficiency.
[2] The positive electrode active material precursor for a lithium-ion secondary battery according to [1], wherein the core portion does not include the same crystal structure as that of an α-type nickel hydroxide.

In the precursor according to [2], the core portion does not include the same crystal structure as that of an α-type nickel hydroxide. This means that the core portion is composed only of a β-type nickel hydroxide. The β-type nickel hydroxide has a low content of anionic impurities such as sulfate ions and a high bulk density. Therefore, a reaction (firing reaction) at the time of firing the precursor is uniform, and a distribution of iron in the positive electrode active material is uniform. Therefore, a discharge capacity of the secondary battery can be further increased.
[3] The positive electrode active material precursor for a lithium-ion secondary battery according to [1] or [2], wherein the shell portion contains one or more iron compounds selected from iron (II) hydroxide, iron (III) hydroxide, iron oxyhydroxide, and triiron tetraoxide.

In the precursor according to [3], the shell portion contains a mixture of specific iron compounds. Therefore, uniformity of a distribution of iron in the shell portion can be further enhanced. Therefore, a discharge capacity of the secondary battery can be further increased.
[4] The positive electrode active material precursor for a lithium-ion secondary battery according to any one of [1] to [3], having an average particle size of 1 to 25 μm and a tap density of 1.30 g/mL or more.

The precursor according to [4] has a specific average particle size and a specific tap density. Therefore, in a fired positive electrode active material, for example, an electrical characteristic at the time of high rate discharge such as 5 C can be enhanced, and an electrode packing density can be increased. Therefore, a discharge capacity of the secondary battery can be further increased.
[5] The positive electrode active material precursor for a lithium-ion secondary battery according to any one of [1] to [4], having a specific surface area of 2 to 50 m²/g.

The precursor according to [5] has a specified specific surface area. Therefore, a firing reaction at the time of firing the precursor sufficiently proceeds, and a discharge capacity of the secondary battery can be further increased.
[6] A method for producing the positive electrode active material precursor for a lithium-ion secondary battery according to any one of [1] to [5], the method including
   a step of coating a hydroxide containing nickel and aluminum with an iron compound under an inert gas atmosphere.

The method for producing a precursor according to [6] includes a step of coating a hydroxide containing nickel and aluminum with an iron compound under an inert gas atmosphere. Therefore, oxidation of iron (II) ions can be suppressed, and a shell portion having a uniform layer can be obtained. Therefore, a discharge capacity of the secondary battery can be further increased.

According to the positive electrode active material precursor for a lithium-ion secondary battery and the method for producing a positive electrode active material precursor for a lithium-ion secondary battery according to the present invention, a lithium-ion secondary battery capable of further increasing a discharge capacity can be obtained.

### BRIEF DESCRIPTION OF DRAWINGS

FIG. 1 is a cross-sectional view schematically illustrating a lithium-ion secondary battery prepared in Examples;

FIG. 2 is an example of a scanning electron microscope (SEM) image of a precursor of Example 1;

FIG. 3 is an example of a scanning electron microscope energy dispersive fluorescent X-ray spectroscopy (SEM-EDX) image of the precursor of Example 1;

FIG. 4 is a diagram illustrating an X-ray diffraction (XRD) pattern of the precursor of Example 1;

FIG. 5 is a diagram illustrating an XRD pattern of a precursor of Example 2;

FIG. 6 is a diagram illustrating an XRD pattern of a precursor of Comparative Example 1;

FIG. 7 is a diagram illustrating an XRD pattern of a precursor of Comparative Example 2;

FIG. 8 is a diagram illustrating an XRD pattern of a positive electrode active material of Example 3;

FIG. 9 is a diagram illustrating an XRD pattern of a positive electrode active material of Example 4;

FIG. 10 is a diagram illustrating an XRD pattern of a positive electrode active material of Comparative Example 3;

FIG. 11 is a diagram illustrating an XRD pattern of a positive electrode active material of Comparative Example 4;

FIG. 12 is a diagram illustrating a discharge curve of a lithium-ion secondary battery of Example 3;

FIG. 13 is a diagram illustrating a discharge curve of a lithium-ion secondary battery of Example 4;

FIG. 14 is a diagram illustrating a discharge curve of a lithium-ion secondary battery of Comparative Example 3; and

FIG. 15 is a diagram illustrating a discharge curve of a lithium-ion secondary battery of Comparative Example 4.

### DETAILED DESCRIPTION

Hereinafter, a preferred embodiment of the present invention will be described in detail.

### [Positive Electrode Active Material Precursor for Lithium-Ion Secondary Battery]

A positive electrode active material precursor for a lithium-ion secondary battery (hereinafter, also simply referred to as a “precursor”) of the present embodiment contains a metal composite hydroxide. The metal composite hydroxide is in a form of a particle having a core-shell structure whose surface is coated with an iron compound, and is present as a metal composite hydroxide particle.

The precursor of the present embodiment is an aggregate of metal composite hydroxide particles, and is a material serving as a raw material of a positive electrode active material for a lithium-ion secondary battery (hereinafter, also simply referred to as a “positive electrode active material”) used for a positive electrode of a lithium-ion secondary battery (hereinafter, also simply referred to as a “secondary battery”).

In the precursor, the metal composite hydroxide particle may be a primary particle or a secondary particle in which primary particles are aggregated.

The content of the metal composite hydroxide particle in the precursor is, for example, preferably 80% by mass or more, more preferably 90% by mass or more, still more preferably 95% by mass or more, and may be 100% by mass. The precursor may contain a component other than the metal composite hydroxide particle as long as a function of the present invention is not impaired.

The metal composite hydroxide particle has a core-shell structure constituted by a core portion and a shell portion.

The core portion contains nickel and aluminum as metal elements.

The shell portion contains iron as a metal element.

The core portion and the shell portion can be easily distinguished from each other by a scanning electron microscope energy dispersive fluorescent X-ray spectroscopy (SEM-EDX) image or the like.

A composition of the core portion can be represented by Ni₍₁₋ₓ₎Alₓ(OH)₂.

At this time, x satisfies 0.01≤x≤0.2.
x represents the number of moles of aluminum when the number of moles of hydroxy groups is 2. When x is the above lower limit value or more, thermal stability of a positive electrode active material obtained from the precursor can be enhanced. When x is the above upper limit value or less, a discharge capacity of a secondary battery using a positive electrode active material obtained from the precursor can be increased.
x is preferably 0.02 to 0.15, and more preferably 0.03 to 0.1.
x can be adjusted by a molar ratio between a nickel compound and an aluminum compound.
x can be determined, for example, by inductively coupled plasma (ICP) emission spectral analysis.

When a molar amount of the metal element in the core portion is represented by M₁ and a molar amount of the metal element in the shell portion is represented by M₂, a molar ratio (M₂/M₁) satisfies M₂/M₁=1/100 to 1/5.

When M₂/M₁ is the above lower limit value or more, a surface of a positive electrode active material obtained from the precursor can be suppressed from being rich in aluminum, and a discharge capacity of a secondary battery using the positive electrode active material can be increased. When M₂/M₁ is the above upper limit value or less, a sufficient nickel ratio can be maintained, and a discharge capacity of a secondary battery using a positive electrode active material obtained from the precursor can be increased.

M₂/M₁ is preferably 1/100 to 1/10, and more preferably 1/100 to 3/20.

M₂/M₁ can be determined, for example, by inductively coupled plasma (ICP) emission spectral analysis.

The size of the core portion and the thickness of the shell portion can be appropriately adjusted within a range satisfying the above-described molar ratio (M₂/M₁=1/100 to 1/5).

The core portion preferably does not contain the same crystal structure as that of an α-type nickel hydroxide. The α-type nickel hydroxide contains a large amount of anionic impurities such as sulfate ions, and a reaction (firing reaction) at the time of firing the precursor is non-uniform, leading to a decrease in discharge capacity of a secondary battery using a positive electrode active material obtained from the precursor. “The core portion does not contain the same crystal structure as that of an α-type nickel hydroxide” means that the core portion is composed only of a β-type nickel hydroxide. The β-type nickel hydroxide has a low content of anionic impurities such as sulfate ions and a high bulk density. Therefore, a reaction (firing reaction) at the time of firing the precursor is uniform, and a distribution of iron in the positive electrode active material is uniform. Therefore, a discharge capacity of the secondary battery can be further increased.

Note that, in the present specification, “the core portion does not contain the same crystal structure as that of an α-type nickel hydroxide” does not mean that the same crystal structure as that of an α-type nickel hydroxide is not contained at all, but means that the inevitably contained same crystal structure as that of an α-type nickel hydroxide is allowed.

The crystal structure of the core portion can be specified by an X-ray diffraction method (XRD).

The shell portion preferably contains one or more iron compounds selected from iron (II) hydroxide, iron (III) hydroxide, iron oxyhydroxide, and triiron tetraoxide. By inclusion of a specific iron compound in the shell portion, uniformity of a distribution of iron in the shell portion can be further enhanced. Therefore, a discharge capacity of a lithium-ion secondary battery using a positive electrode active material obtained from the precursor can be further increased.

As the iron compound contained in the shell portion, iron (II) hydroxide, iron oxyhydroxide, and triiron tetraoxide are preferable, and iron (II) hydroxide is more preferable.

One type or two or more types of iron compounds may be contained in the shell portion.

The shell portion may contain a small amount of impurities other than the iron compound.

The type of iron compound contained in the shell portion can be specified by Raman spectroscopy.

An average particle size of the precursor is preferably 1 to 25 μm, more preferably 2 to 20 μm, and still more preferably 3 to 15 μm. When the average particle size of the precursor is the above lower limit value or more, productivity of the precursor can be further increased. When the average particle size of the precursor is the above upper limit value or less, an electrical characteristic at the time of high rate discharge such as 5 C can be enhanced.

The average particle size of the precursor means, for example, D50 measured by a laser diffraction particle size distribution measuring apparatus or the like.

A tap density of the precursor is preferably 1.30 g/mL or more, more preferably 1.32 g/mL or more, and still more preferably 1.35 g/mL or more. When the tap density of the precursor is the above lower limit value or more, an electrode packing density can be increased. Therefore, a discharge capacity of the secondary battery can be further increased. An upper limit value of the tap density of the precursor is not particularly limited, but is, for example, 2.50 g/mL.

The tap density of the precursor is determined, for example, by the following method.

### <Method for Measuring Tap Density>

The tap density is an increased bulk density obtained after a container containing a powder sample is mechanically tapped.

The tap density is obtained by mechanically tapping a measurement container containing a powder sample. After an initial volume or mass of a powder is measured, a measurement container is mechanically tapped, and a volume or a mass is read until almost no change in volume or mass is observed. Mechanical tapping is performed by lifting a container and dropping the container a predetermined distance under its own weight by a method described below.

### (Operation Method)

Using a suitable tap density tester, a measurement container is tapped 50 to 60 times/min. The measurement container is tapped 200 times, a tap density (g/mL) is calculated from sample weight (g)/packing volume (mL) after tapping, and an average of three measurement values using three different samples is recorded. Test conditions including a tap height are described in items of results.

A specific surface area of the precursor is preferably 2 to 50 m²/g, more preferably 5 to 40 m²/g, and still more preferably 10 to 30 m²/g. When the specific surface area of the precursor is the above lower limit value or more, a firing reaction at the time of firing the precursor sufficiently proceeds, and a discharge capacity of the secondary battery can be further increased. When the specific surface area of the precursor is the above upper limit value or less, it is possible to suppress peeling of the shell portion in a mixing step with a lithium source.

The specific surface area of the precursor can be determined by a BET method.

### [Method for Producing Precursor]

The method for producing a precursor according to the present embodiment includes a step of coating a hydroxide containing nickel and aluminum with an iron compound under an inert gas atmosphere (hereinafter, also referred to as a “coating step”). By inclusion of the coating step in the method for producing a precursor according to the present embodiment, a metal composite hydroxide particle having a core-shell structure whose surface is coated with an iron compound can be obtained.

Hereinafter, the coating step will be described.

### <Coating Step>

The hydroxide containing nickel and aluminum (hereinafter, also referred to as a “nickel-aluminum coprecipitated hydroxide”) is obtained in a coprecipitation step described later.

The nickel-aluminum coprecipitated hydroxide is preferably coated with an iron compound under an inert gas atmosphere.

By performing the coating step in an inert gas atmosphere, oxidation of iron (II) ions can be suppressed, and a shell portion having a uniform layer can be obtained. Therefore, a discharge capacity of the secondary battery can be further increased.

On the other hand, when the coating step is performed in the presence of an oxygen gas, iron (II) ions are oxidized by dissolved oxygen, a uniform layer cannot be obtained, and a particle in which the core portion is exposed may be obtained. That is, a particle not having a core-shell structure may be obtained.

Examples of the inert gas used in the coating step include an oxygen-free gas such as a nitrogen gas, a helium gas, or an argon gas. The inert gas used in the coating step is preferably a nitrogen gas from an economical viewpoint.

A flow rate of the inert gas is not particularly limited as long as mixing of an oxygen gas can be prevented.

In the coating step, the nickel-aluminum coprecipitated hydroxide is preferably mixed with water to prepare a slurry liquid. By using the slurry liquid, the nickel-aluminum coprecipitated hydroxide can be easily coated with an iron compound uniformly. Therefore, a metal composite hydroxide particle having a uniform layer shell portion is easily obtained.

The slurry liquid preferably has a pH of 8 to 10 at 75° C.

The pH can be adjusted using a sulfuric acid aqueous solution, a sodium hydroxide aqueous solution, or the like.

The pH can be measured using a pH meter or the like while the temperature of a measurement object is 75° C.

The temperature of the slurry liquid in the coating step is preferably 70 to 80° C.

Examples of the iron compound in the coating step include iron (II) sulfate and iron (II) chloride. The valence of an iron ion in the iron compound is more preferably 2 than 3. By coating with an iron compound containing a divalent iron ion, a metal composite hydroxide particle having a uniform layer shell portion is easily obtained.

The method for producing a precursor according to the present embodiment may include a step other than the coating step.

Examples of the step other than the coating step include a coprecipitation step, a dehydration step, a drying step, and a sieving step.

### <Coprecipitation Step>

The nickel-aluminum coprecipitated hydroxide is obtained by coprecipitating a nickel compound and an aluminum compound in an alkali solution (coprecipitation step).

Examples of the nickel compound include nickel sulfate, nickel nitrate, and nickel chloride.

Examples of the aluminum compound include aluminum sulfate, aluminum nitrate, and aluminum chloride.

Examples of the alkali solution include aqueous ammonia, a sodium hydroxide aqueous solution, and a mixed solution thereof.

A molar ratio between the nickel compound and the aluminum compound in the coprecipitation step is preferably 99:1 to 80:20, and more preferably 98:2 to 70:30 in terms of a molar ratio between a nickel element and an aluminum element. By setting the molar ratio between the nickel compound and the aluminum compound in the coprecipitation step within the above numerical range, a positive electrode active material having high thermal stability can be obtained, and a discharge capacity of a secondary battery using the positive electrode active material can be further increased.

The pH of the alkali solution in the coprecipitation step is preferably 10 to 12 at 50° C.

The pH can be adjusted using a sulfuric acid aqueous solution, a sodium hydroxide aqueous solution, or the like.

The pH can be measured using a pH meter or the like while the temperature of a measurement object is 50° C.

A reaction temperature in the coprecipitation step is preferably 40 to 60° C.

A reaction time in the coprecipitation step is preferably 30 to 50 hours.

In the coprecipitation step, preferably, a slurry liquid obtained by a reaction is dehydrated and washed with water.

### <Dehydration Step>

The dehydration step is a step of dehydrating the slurry liquid obtained in the coprecipitation step or the coating step.

A dehydration method in the dehydration step is not particularly limited, and can be performed by a conventionally known method.

The dehydration step is preferably performed under an inert gas atmosphere from a viewpoint of suppressing oxidation of an iron compound.

### <Drying Step>

The drying step is a step of drying the metal composite hydroxide after dehydration of the slurry liquid to obtain a powdery metal composite hydroxide particle. By obtaining the powdery metal composite hydroxide particle, it is possible to more easily prepare a positive electrode active material from the precursor.

A drying method in the drying step is not particularly limited, and can be performed by a conventionally known method.

The drying step is preferably performed under an inert gas atmosphere from a viewpoint of suppressing oxidation of an iron compound.

A drying temperature in the drying step is preferably 100 to 120° C.

A drying time in the drying step is preferably 5 to 15 hours.

### <Sieving Step>

The particle size of an aggregate (precursor) of the powdery metal composite hydroxide particles obtained in the drying step is preferably adjusted using a sieve (sieving step). By inclusion of the sieving step, an average particle size of the precursor can be easily adjusted, and in a secondary battery using a positive electrode active material obtained from the precursor, an electrical characteristic at the time of high rate discharge such as 5 C can be further enhanced.

A sieve used in the sieving step is not particularly limited, and a conventionally known sieve can be used.

A mesh size of a sieve used in the sieving step is not particularly limited, and a mesh size that makes an average particle size of the precursor 1 to 25 μm is preferable. Examples of such a sieve include a sieve having a mesh size of 100 to 200.

### [Positive Electrode Active Material]

A positive electrode active material of the present embodiment contains a lithium transition metal composite oxide as a main component, and is used in a positive electrode of a lithium-ion secondary battery. The phrase “contains a lithium transition metal composite oxide as a main component” means that the content of the lithium transition metal composite oxide is 75% by mass or more, preferably 80% by mass or more, more preferably 90% by mass or more, and still more preferably 95% by mass or more with respect to the total mass of the positive electrode active material, and may be 100% by mass. The positive electrode active material may contain a component other than the main component as long as a function of the present invention is not impaired.

The positive electrode active material of the present embodiment may contain only one type or two or more types of lithium transition metal composite oxides as long as the lithium transition metal composite oxide is contained as a main component.

When the positive electrode active material is produced by using the lithium transition metal composite oxide as a main component, a composition ratio (Li:Ni:Al:Fe) of the entire lithium transition metal composite oxide is also maintained in an obtained positive electrode active material. When a positive electrode active material obtained by using the lithium transition metal composite oxide having such a composition as a main component is used in a secondary battery, a high capacity can be achieved. In addition, the composition ratio of the lithium transition metal composite oxide is adjusted so as to be similar to a composition ratio required for a positive electrode active material to be obtained.

### <Lithium Transition Metal Composite Oxide>

The lithium transition metal composite oxide of the present embodiment is a layered rock salt type oxide and is in a form of a particle having an outer layer on a surface thereof.

In the present specification, an average particle size of particles of the lithium transition metal composite oxide is not particularly limited, but is, for example, preferably 2 to 30 μm, more preferably 3 to 20 μm, and still more preferably 5 to 15 μm. When the average particle size of particles of the lithium transition metal composite oxide is the above lower limit value or more, productivity of the positive electrode active material can be further enhanced. When the average particle size of particles of the lithium transition metal composite oxide is the above upper limit value or less, an electrochemical characteristic of the secondary battery can be further improved.

The average particle size of particles of the lithium transition metal composite oxide means, for example, D50 measured by a laser diffraction particle size distribution measuring apparatus or the like.

The lithium transition metal composite oxide of the present embodiment is represented by the following formula (1).

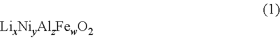

In formula (1), x, y, z, and w are in ranges of 0.95≤x≤1.05, 0.78≤y≤0.95, 0.01≤z≤0.15, and 0.01≤w≤0.15, respectively, and x+y+z+w=2 is satisfied.

In the lithium transition metal composite oxide of the present embodiment, x, y, z, and w are more preferably in ranges of 0.97≤x≤1.03, 0.80≤y≤0.92, 0.04≤z≤0.09, and 0.04≤w≤0.12, respectively in formula (1).

A chemical composition of the lithium transition metal composite oxide of the present embodiment can be determined by inductively coupled plasma (ICP) emission spectral analysis.

### <Surface Composition>

The particle of the lithium transition metal composite oxide has an outer layer on a surface thereof.

In the present specification, the “outer layer” refers to a region up to 25 nm from a surface of a particle toward the inside of the particle. Note that when a particle size is less than 50 nm, the particle has a single layer structure composed only of an outer layer.

In the particles of the lithium transition metal composite oxide of the present embodiment, a ratio between a ratio of the number of atoms of Fe to the number of atoms of Ni in the outer layer (Fe/Ni ratio) and a Fe/Ni ratio in the entire particle (hereinafter, also referred to as “Fe/Ni ratio in ‘outer layer/entire particle’”) is preferably uniform.

More specifically, the Fe/Ni ratio in ‘outer layer/entire particle’ is preferably 0.7 or more and 1.7 or less, more preferably 0.9 or more and 1.5 or less, and still more preferably 1.1 or more and 1.3 or less. When the Fe/Ni ratio in ‘outer layer/entire particle’ is within the above numerical range, movement of lithium ions is not inhibited, and a charge and discharge capacity of a secondary battery can be further increased when the particles of the lithium transition metal composite oxide are used as a positive electrode active material.

The Fe/Ni ratio can be determined by quantitative analysis of X-ray photoelectron spectroscopy (XPS). According to XPS, a composition of a transition metal element in the entire particle can be analyzed. That is, an analysis result obtained by XPS does not indicate a local composition of the entire surface of one particle, but indicates a composition of the entire surface of the particle.

The particle of the lithium transition metal composite oxide of the present embodiment may be a primary particle or a secondary particle. The particle of the lithium transition metal composite oxide is preferably a secondary particle in which a plurality of primary particles are aggregated with each other from a viewpoint that relatively dense particles can be obtained.

### <Lattice Constant>

The lithium transition metal composite oxide of the present embodiment is a rhombohedral layered compound, and has a crystal structure of a space group R-3m. With regard to a lattice constant of the positive electrode active material of the present embodiment containing the lithium transition metal composite oxide as a main component, an a-axis length is preferably 2.860 Å to 2.890 Å, and a c-axis length is preferably 14.18 Å to 14.28 Å. With the lattice constant within the above range, in the positive electrode active material, lithium ions are easily diffused in a primary particle, and the positive electrode active material has low resistance.

A lattice constant of a crystal can be determined by a least square method by measuring an X-ray diffraction pattern of the positive electrode active material and using each index and a plane spacing thereof.

### <X-Ray Diffraction (XRD) Pattern>

In the positive electrode active material of the present embodiment, a ratio (I₁/I₂) of an integrated intensity (I₁) of a diffraction peak of a 003 plane to an integrated intensity (I₂) of a diffraction peak of a 104 plane in a space group R-3m measured by X-ray diffraction (XRD) is preferably 1.15 or more and 1.35 or less, more preferably 1.20 or more and 1.30 or less, and still more preferably 1.23 or more and 1.27 or less. With the integrated intensity ratio (I₁/I₂) within the above numerical range, cation mixing is reduced, and lithium ions are easily diffused. Therefore, a discharge capacity and an average discharge voltage of the secondary battery can be further increased.

The integrated intensity ratio (I₁/I₂) is determined by analyzing an XRD pattern.

### [Method for Producing Positive Electrode Active Material]

The positive electrode active material of the present embodiment can be synthesized using the precursor of the present embodiment. For example, a composite hydroxide of a nickel compound, an aluminum compound, and an iron compound is prepared as a precursor, the precursor and a lithium compound are mixed to obtain a raw material mixture (mixing step), and the raw material mixture is heat-treated (for example, fired) at a predetermined temperature for a predetermined time in a predetermined atmosphere, whereby the positive electrode active material can be synthesized (heat treatment step).

### <Mixing Step>

The mixing step is a step of mixing a lithium compound and the precursor of the present embodiment to obtain a raw material mixture.

The lithium compound is not particularly limited, but examples thereof include a hydroxide such as lithium hydroxide monohydrate (LiOH·H₂O), a carbonate such as lithium carbonate (Li₂CO₃), and an acetate such as lithium acetate (CH₃COOLi) or lithium acetate dihydrate (CH₃COOLi·2H₂O).

These lithium compounds may be used singly or in combination of two or more types thereof.

A known mixer can be used for mixing the lithium compound and the precursor.

Examples of such a mixer include a shaker mixer, a Loedige mixer, a Julia mixer, and a V blender.

Mixing conditions in the mixing step are not particularly limited, but it is preferable to select conditions such that components serving as raw materials are sufficiently mixed to an extent that the shapes of particles and the like of the raw materials such as the precursor are not broken.

A particle size or the like of each of the lithium compound and the precursor is preferably adjusted in advance such that a desired lithium transition metal composite oxide can be obtained after the heat treatment step.

The lithium compound and the precursor are preferably mixed by weighing lithium, nickel, aluminum, and iron in the raw material mixture after mixing such that a ratio among the amounts of substances in the lithium transition metal composite oxide is Li:Ni:Al:Fe=x:y:z:w after the heat treatment step. More specifically, the lithium compound is weighed more than a stoichiometric ratio by 1% by mass to 5% by mass, preferably about 1 to 3% by mass.

Here, x, y, z, and w can be in the same ranges as those described for the lithium transition metal composite oxide in the positive electrode active material.

### <Heat Treatment Step>

The heat treatment step is a step of heat-treating the raw material mixture obtained in the mixing step at a predetermined temperature for a predetermined time in a predetermined atmosphere.

In the heat treatment step, the raw material mixture is filled into a crucible or the like, and the mixture is heat-treated. As the crucible, for example, an alumina sagger, an alumina crucible, a platinum crucible, or a gold crucible is used. In the heat treatment of the raw material mixture, for example, a firing furnace or a roller hearth kiln is used.

The raw material mixture put in a sagger or a crucible is heated at a temperature-rising rate of 5° C./min to 25° C./min, preferably 10° C./min to 25° C./min such that the temperature reaches a heat treatment temperature. A heat treatment atmosphere is not particularly limited, and examples thereof include the atmosphere (under an air atmosphere) and an oxygen flow. The heat treatment atmosphere is preferably an oxygen flow. A heat treatment time can be appropriately set according to a heat treatment temperature. Note that the heat treatment time means time for holding the heat treatment temperature.

The heat treatment temperature is preferably 700° C. or higher and 800° C. or lower, and more preferably 720° C. or higher and 780° C. or lower. The heat treatment time is preferably one hour or more and 20 hours or less, and more preferably three hours or more and 15 hours or less.

The method for producing a positive electrode active material according to the present embodiment may include a step other than the mixing step and the heat treatment step.

Examples of such a step include a cooling step.

### <Cooling Step>

The cooling step is a step of cooling the lithium transition metal composite oxide obtained in the heat treatment step to a predetermined temperature at a predetermined temperature-lowering rate.

In the cooling step, for example, the powder obtained in the heat treatment step is cooled at a temperature-lowering rate of 5° C./min to 25° C./min, preferably 10° C./min to 25° C./min until the temperature reaches room temperature (for example, 25° C.). An atmosphere for cooling the powder is not particularly limited, and examples thereof include an atmosphere (under an air atmosphere), an air flow, and an oxygen flow.

In the positive electrode active material of the present embodiment, by appropriately selecting the heat treatment temperature and the heat treatment time in the heat treatment step, the Fe/Ni ratio in ‘outer layer/entire particle’ of the lithium transition metal composite oxide can be more easily adjusted to a specific range.

### [Lithium-Ion Secondary Battery]

The lithium-ion secondary battery (hereinafter, also simply referred to as a “secondary battery”) of the present embodiment includes a positive electrode, a negative electrode, and an electrolyte, and the positive electrode contains a positive electrode active material containing the above-described lithium transition metal composite oxide as a main component. The secondary battery of the present embodiment may include another battery element as necessary.

In the secondary battery of the present embodiment, a battery element of a known lithium-ion secondary battery can be adopted as it is except that the positive electrode contains a positive electrode active material containing the above-described lithium transition metal composite oxide as a main component. The secondary battery of the present embodiment may have any of coin type, button type, cylindrical type, square type, and laminate type configurations. In addition, the secondary battery of the present embodiment is applicable to a wide range of applications such as a mobile device such as a mobile phone or a laptop computer and an in-vehicle application.

Hereinafter, with respect to the secondary battery of the present embodiment, a secondary battery (coin-type lithium-ion secondary battery) using an electrolytic solution will be described. Each battery element described below can be similarly applied to an all-solid-state lithium-ion secondary battery not using an electrolytic solution.

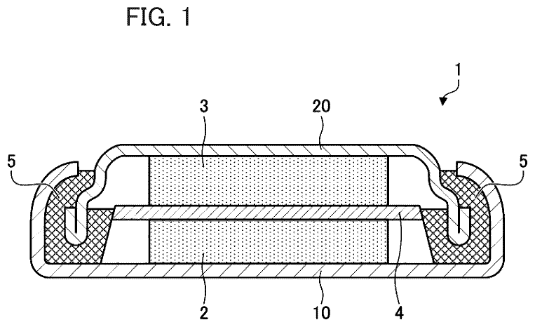

FIG. 1 is a cross-sectional view schematically illustrating the lithium-ion secondary battery according to the present embodiment. FIG. 1 illustrates an example in which the lithium-ion secondary battery of the present embodiment is a coin-type lithium-ion secondary battery. As illustrated in FIG. 1, a lithium-ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed on a lower side of the separator 4, the negative electrode can 20 is disposed on an upper side of the separator 4, and an outer shape of the lithium-ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium-ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the conductive agent in the positive electrode mixture is preferably 1% by mass to 15% by mass, and more preferably 0.1% by mass to 5% by mass. The content of the binder in the positive electrode mixture is preferably 0.1% by mass to 10% by mass, and more preferably 0.1% by mass to 5% by mass. It is preferable to blend the positive electrode active material, the conductive agent, and the binder such that a remainder (a portion other than the binder and the conductive agent) in the positive electrode mixture is the positive electrode active material.

In the lithium-ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), or a silicon-based material such as silicon (Si), a Si alloy, or silicon oxide can be adopted.

Known battery elements can be adopted as the separator 4 and the battery containers (positive electrode can 10 and negative electrode can 20).

As the electrolyte, a known electrolytic solution, a known solid electrolyte, or the like can be adopted. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state lithium-ion secondary battery can have a similar structure to that of a known all-solid-state lithium-ion secondary battery except that a positive electrode active material containing the above-described lithium transition metal composite oxide as a main component is used.

In the case of the all-solid-state lithium-ion secondary battery, as the electrolyte, for example, a solid electrolyte such as a polymer-based solid electrolyte such as a polyethylene oxide-based polymer compound or a polymer compound including at least one of a polyorganosiloxane chain and a polyoxyalkylene chain, a sulfide-based solid electrolyte, or an oxide-based solid electrolyte can be used.

As for a positive electrode of the all-solid-state lithium-ion secondary battery, for example, a positive electrode mixture containing a solid electrolyte in addition to the positive electrode active material, the conductive agent, and the binder described above can be carried on a positive electrode current collector such as aluminum, nickel, or stainless steel.

In the lithium-ion secondary battery 1 of the present embodiment, since the positive electrode 2 contains a positive electrode active material containing the above-described lithium transition metal composite oxide as a main component, a discharge capacity can be further increased.

### EXAMPLES

Hereinafter, Examples of the present invention will be described, but the present invention is not limited to Examples below.

### Example 1

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.10 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.10±0.05 (measured value at 50° C.).

A high-density hydroxide having a median diameter of 10.5 μm and a tap density of 1.8 g/mL was obtained about 30 hours after start of the reaction at which a slurry concentration became steady. Subsequently, the reaction was allowed to proceed while a liquid property of the reaction liquid was controlled, and a slurry discharged from the overflow tube during 30 hours to 50 hours after start of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 9.00±0.05 (measured value at 75° C.). In addition, in order to prevent oxidation of iron, purge with a certain amount of nitrogen gas was performed.

Next, while the temperature was maintainer at 75° C. and the slurry liquid was stirred, an iron (II) sulfate aqueous solution adjusted to 10% by weight in terms of metal was continuously added dropwise such that iron (II) hydroxide equivalent to 4.5 mol % of iron was deposited on a surface of nickel hydroxide, and a 25% by mass sodium hydroxide aqueous solution was also added dropwise so as to maintain a pH of 9.00±0.05 (measured value at 75° C.).

As a result, a slurry of a nickel-aluminum hydroxide coated with iron (II) hydroxide was obtained. Subsequently, the obtained slurry was dehydrated, washed with an alkali and washed with water, then dried at 110° C. for 10 hours, and then caused to pass through a 100 mesh sieve to obtain 1 kg of a precursor in which a surface of the nickel-aluminum hydroxide was coated with iron (II) hydroxide.

### Example 2

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.00 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.00±0.05 (measured value at 50° C.).

While a liquid property of the reaction liquid was controlled, a slurry concentration apparatus was connected and a solid-liquid separation operation was continuously performed. Only a filtrate was discharged to the outside of the system, and an operation of increasing a slurry concentration was performed in parallel. A high-density hydroxide having a median diameter of 5.4 μm and a tap density of 1.8 g/mL or more was obtained about 25 hours after start of the reaction. The slurry after completion of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 9.00±0.05 (measured value at 75° C.). In addition, in order to prevent oxidation of iron, purge with a certain amount of nitrogen gas was performed.

Next, while the temperature was maintainer at 75° C. and the slurry liquid was stirred, an iron (II) sulfate aqueous solution adjusted to 10% by weight in terms of metal was continuously added dropwise such that iron (II) hydroxide equivalent to 4.5 mol % of iron was deposited on a surface of nickel hydroxide, and a 25% by mass sodium hydroxide aqueous solution was also added dropwise so as to maintain a pH of 9.00±0.05 (measured value at 75° C.).

As a result, a slurry of a nickel-aluminum hydroxide coated with iron (II) hydroxide was obtained. Subsequently, the obtained slurry was dehydrated, washed with an alkali and washed with water, then dried at 110° C. for 10 hours, and then caused to pass through a 100 mesh sieve to obtain 1 kg of a precursor in which a surface of the nickel-aluminum hydroxide was coated with iron (II) hydroxide.

### Comparative Example 1

### <Preparation of Nickel-Aluminum-Iron Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.00 (measured value at 50° C.).

While the liquid temperature in the beaker was maintained at 50° C. and the mixture in the beaker was stirred at a speed of 600 rpm, a solution adjusted so as to contain nickel sulfate, aluminum sulfate, and iron (II) sulfate at a molar ratio (Ni:Al:Fe=91.0:4.5:4.5) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.00±0.05 (measured value at 50° C.).

While a liquid property of the reaction liquid was controlled, a slurry concentration apparatus was connected and a solid-liquid separation operation was continuously performed. Only a filtrate was discharged to the outside of the system, and an operation of increasing a slurry concentration was performed in parallel. A high-density hydroxide having a median diameter of 4.0 μm and a tap density of 1.57 g/mL or more was obtained about 25 hours after start of the reaction. The slurry after completion of the reaction was dehydrated and washed with water to obtain a nickel-aluminum coprecipitated hydroxide. The slurry after completion of the reaction was dehydrated, washed with an alkali and washed with water, then dried at 110° C. for 10 hours, and then caused to pass through a 100 mesh sieve to obtain a nickel-aluminum-iron coprecipitated hydroxide.

### Comparative Example 2

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.10 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.10±0.05 (measured value at 50° C.).

A high-density hydroxide having a tap density of 1.8 g/mL was obtained about 30 hours after start of the reaction at which a slurry concentration becomes steady. Subsequently, the reaction was allowed to proceed while a liquid property of the reaction liquid was controlled, and a slurry discharged from the overflow tube during 30 hours to 50 hours after start of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 11.00±0.05 (measured value at 75° C.).

Next, while the temperature was maintainer at 75° C. and the slurry liquid was stirred, an iron (II) sulfate aqueous solution adjusted to 10% by weight in terms of metal was continuously added dropwise such that iron (II) hydroxide equivalent to 4.5 mol % of iron was deposited on a surface of nickel hydroxide, and a 25% by mass sodium hydroxide aqueous solution was also added dropwise so as to maintain a pH of 11.00±0.05 (measured value at 75° C.).

As a result, a slurry of a nickel-aluminum hydroxide coated with iron hydroxide was obtained. Subsequently, the obtained slurry was dehydrated, washed with an alkali and washed with water, then dried at 110° C. for 10 hours, and then caused to pass through a 100 mesh sieve to obtain 1 kg of a precursor in which a surface of the nickel-aluminum hydroxide was coated with iron hydroxide.

### (Analysis)

Chemical compositions of the precursors obtained in Examples 1 and 2 and Comparative Examples 1 and 2 were analyzed by an ICP emission spectrophotometer (trade name: Agilent 5110 VDV, manufactured by Agilent Technologies, Inc.), and results thereof are presented in Table 1.

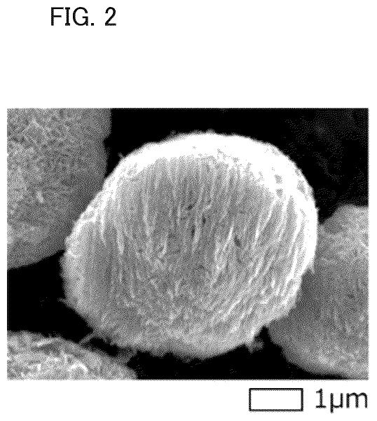

The precursors obtained in Examples 1 and 2 and Comparative Examples 1 and 2 were observed with a scanning electron microscope (SEM). FIG. 2 illustrates an SEM image of the precursor obtained in Example 1.

As illustrated in FIG. 2, it was confirmed that a surface of the precursor of Example 1 was coated with iron hydroxide. This means that the precursor of Example 1 has a core-shell structure.

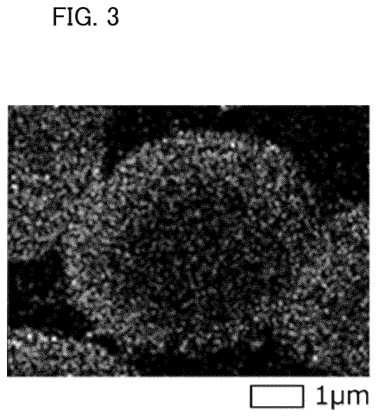

Cross sections of the precursors obtained in Examples 1 and 2 and Comparative Examples 1 and 2 were observed by scanning electron microscope energy dispersive fluorescent X-ray spectroscopy (SEM-EDX). FIG. 3 illustrates an SEM-EDX image of the cross section of the precursor obtained in Example 1. In the SEM-EDX image, a portion appearing white indicates that a large amount of iron element is present.

As illustrated in FIG. 3, it was confirmed that a surface of the precursor of Example 1 was coated with iron hydroxide. This means that the precursor of Example 1 has a core-shell structure. From the SEM images and the SEM-EDX images of the precursors obtained in Examples 1 and 2 and Comparative Examples 1 and 2, it was confirmed that presence or absence of the core-shell structure resulted as illustrated in Table 1.

For the precursors obtained in Examples 1 and 2 and Comparative Examples 1 and 2, an average particle size, a tap density, and a specific surface area were measured on the basis of the following measurement conditions. Results thereof are presented in Table 1.

### <Average Particle Size>

Model name: particle size distribution measuring apparatus SALD-2200
Manufacturer: Shimadzu Corporation
Analysis method: laser diffraction method (wet method)
Refractive index: 1.70+0.20i
Dispersion medium: water
Dispersion method: addition of surfactant, ultrasonic irradiation

### <Tap Density>

Model name: Tap Denser KYT-3000
Manufacturer: Seishin Enterprise Co., Ltd.
Cell volume of measurement container: 100 mL
Number of times of tapping: 200 times
Calculation method: tap density (g/mL)=sample weight (g)/packing volume (mL) after tapping

### <Specific Surface Area>

Model name: Specific surface area analyzer NOVA-2200e
Manufacturer: Quantachrome Instruments
Analysis method: BET multipoint method
Adsorption gas type: Nitrogen gas
Relative pressure: 0.1, 0.2, 0.3
Measurement temperature: 77 K (using liquid nitrogen)

TABLE 1

| | | | | Presence or | Average | | Specific |
|---|---|---|---|---|---|---|---|
| | Composition | | | absence of | particle | Tap | surface |
| | (Molar ratio) | | | core-shell | size | density | area |
| | Ni | Al | Fe | structure | (μm) | (g/ml) | (m²/g) |
| Example 1 | 0.91 | 0.046 | 0.044 | Present | 10.0 | 1.68 | 26.8 |
| Example 2 | 0.91 | 0.047 | 0.042 | Present | 5.1 | 1.37 | 17.9 |
| Comparative | 0.91 | 0.043 | 0.046 | Absent | 4.0 | 1.57 | 22.5 |
| Example 1 | | | | | | | |
| Comparative | 0.91 | 0.047 | 0.046 | Absent | 11.4 | 1.57 | 24.9 |
| Example 2 | | | | | | | |

X-ray diffraction (XRD) patterns of the precursors obtained in Examples 1 and 2 and Comparative Examples 1 and 2 were measured with a powder X-ray diffractometer (trade name: SmartLab, manufactured by Rigaku Corporation). Cu (copper) was used as a target to be irradiated with an electron beam, and a Kα ray was used as a characteristic X-ray.

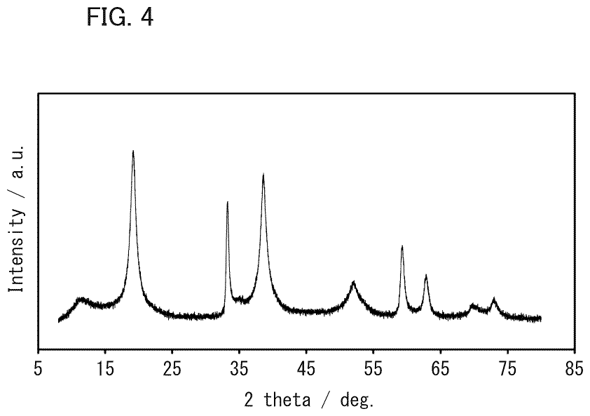

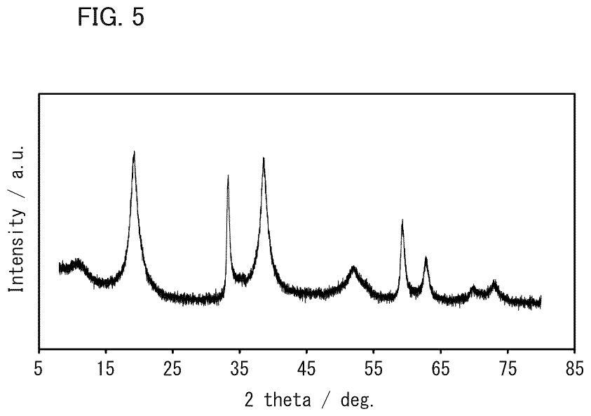

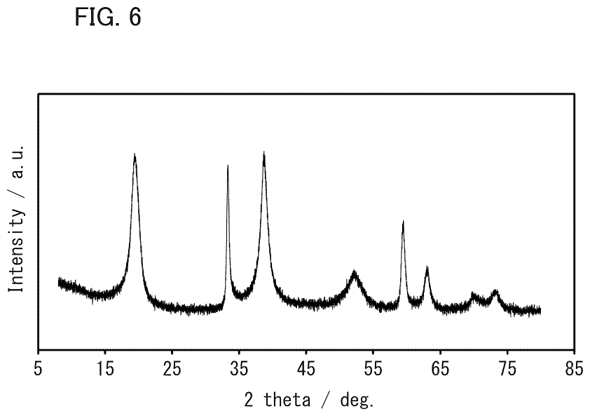

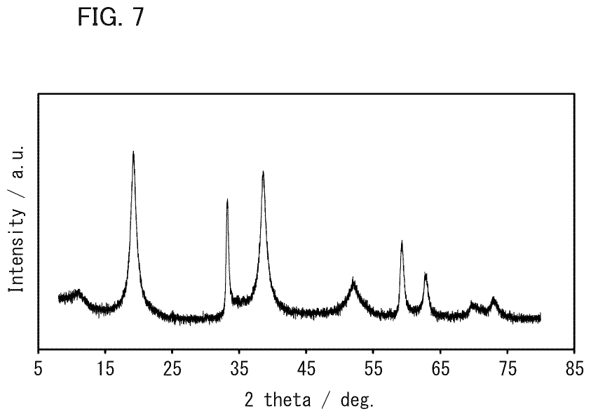

Results thereof are illustrated in FIGS. 4 to 7.

As illustrated in FIGS. 4 to 7, it was confirmed that each of the precursors obtained in Examples 1 and 2 and Comparative Examples 1 and 2 had the same crystal structure as a β-type nickel hydroxide.

### <Preparation of Positive Electrode Active Material>

### Example 3

1.38 g of the precursor obtained in Example 1 and 0.65 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Example 3 having a chemical composition presented in Table 2.

### Example 4

A positive electrode active material of Example 4 having a chemical composition presented in Table 2 was obtained in a similar manner to Example 3 except that the precursor obtained in Example 2 was used.

### Comparative Example 3

A positive electrode active material of Comparative Example 3 having a chemical composition presented in Table 2 was obtained in a similar manner to Example 3 except that the precursor obtained in Comparative Example 1 was used.

### Comparative Example 4

A positive electrode active material of Comparative Example 4 having a chemical composition presented in Table 2 was obtained in a similar manner to Example 3 except that the precursor obtained in Comparative Example 2 was used.

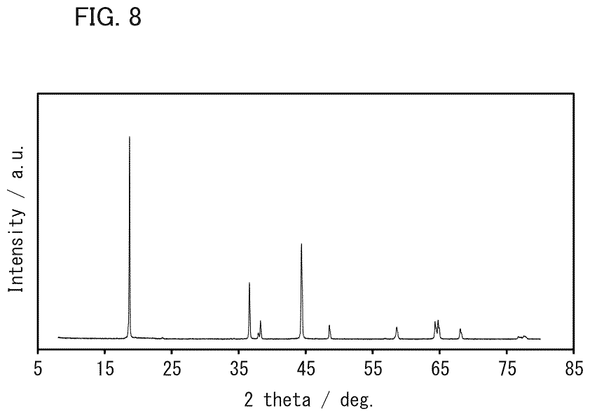

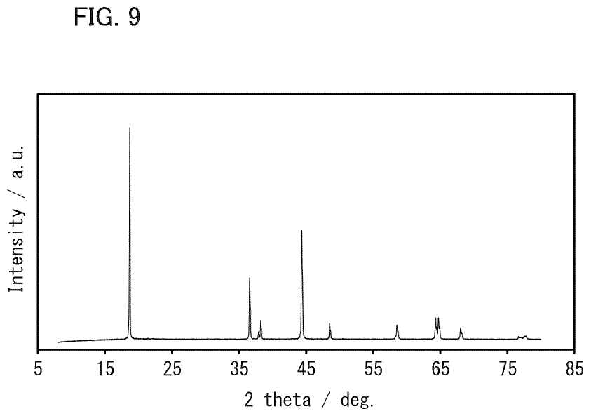

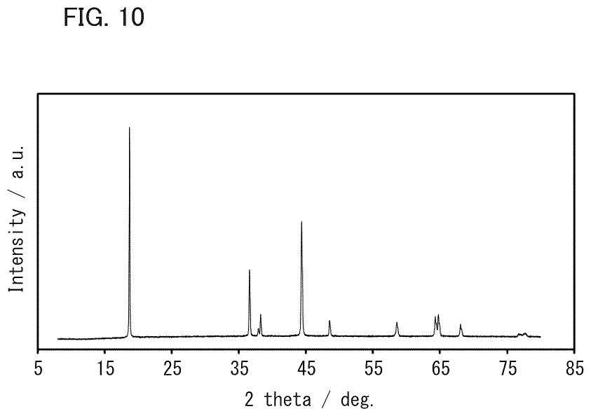

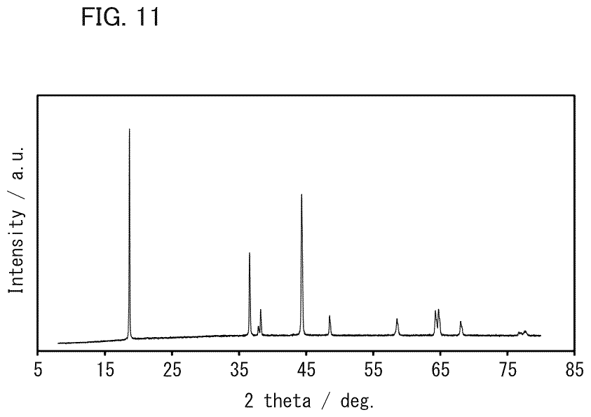

X-ray diffraction (XRD) patterns of the positive electrode active materials obtained in Examples 3 and 4 and Comparative Examples 3 and 4 were measured with a powder X-ray diffractometer (trade name: SmartLab, manufactured by Rigaku Corporation). Cu (copper) was used as a target to be irradiated with an electron beam, and a Kα ray was used as a characteristic X-ray. A lattice constant was determined by a least square method using each index of each of the obtained XRD patterns and a plane spacing thereof. The powder X-ray diffraction patterns in Examples 3 and 4 and Comparative Examples 3 and 4 are illustrated in FIGS. 8 to 11, respectively. A lattice constant value is presented in Table 2.

As illustrated in FIGS. 8 to 11, it was confirmed that each of the positive electrode active materials obtained in Examples 3 and 4 and Comparative Examples 3 and 4 had the same crystal structure as a rhombohedral layered compound.

Results obtained by analyzing compositions of surface layers of the positive electrode active materials obtained in Examples 3 and 4 and Comparative Examples 3 and 4 by quantitative analysis with an X-ray photoelectron spectroscopy (XPS) analyzer (trade name: K-Alpha⁺, manufactured by Thermo Fisher Scientific) are presented in Table 2. Note that measurement conditions of the XPS measurement are described below.

### <<XPS Measurement Conditions>>

Model used: manufactured by Thermo Fisher Scientific,
K-Alpha⁺ (trade name)
Irradiation X-ray: single crystal spectroscopic Alka (12 keV, 72 W)
X-ray spot diameter: 400 μm
Neutralization electron gun: used
Reference spectrum: C—C, C—H 284.6 eV
Detection depth: 6 to 7 nm

An integrated intensity ratio (I₁/I₂) was determined from the XRD patterns of the positive electrode active materials obtained in Examples 3 and 4 and Comparative Examples 3 and 4. Results thereof are presented in Table 2.

TABLE 2

| | | | | | Comparative | Comparative |
|---|---|---|---|---|---|---|
| | | | Example 3 | Example 4 | Example 3 | Example 4 |
| Precursor | | | Example 1 | Example 2 | Comparative | Comparative |
| | | | | | Example 1 | Example 2 |
| Positive | Chemical | Li | 0.99 | 1.00 | 1.00 | 1.00 |
| electrode | composition | Ni | 0.92 | 0.91 | 0.88 | 0.87 |
| active | (Molar | Al | 0.047 | 0.047 | 0.042 | 0.045 |
| material | ratio) | Fe | 0.045 | 0.042 | 0.044 | 0.044 |
| | Fe/Ni | Entire particle | 0.049 | 0.046 | 0.05 | 0.051 |
| | ratio | Outer layer | 0.054 | 0.071 | 0.054 | 0.048 |
| | | Outer layer/ | 1.11 | 1.56 | 1.08 | 0.94 |
| | | entire particle | | | | |
| | Heat treatment | | 750° C. | 750° C. | 750° C. | 750° C. |
| | conditions | | 10 h | 10 h | 10 h | 10 h |
| | Lattice | a(Å) | 2.87711(7) | 2.87692(7) | 2.87684(8) | 2.87679(10) |
| | constant | c(Å) | 14.2309(4) | 14.2270(4) | 14.2321(5) | 14.2344(6) |
| | Integrated intensity | | 1.25 | 1.23 | 1.06 | 0.85 |
| | ratio(I₁/I₂) | | | | | |
| | Average particle | | 11.63 | 8.45 | 7.09 | 13.04 |
| | size(μm) D50 | | | | | |
| Battery | Discharge | 0.05 C | 214 | 222 | 216 | 210 |
| characteristics | capacity | 5 C | 174 | 175 | 156 | 164 |
| | (mAh/g) | | | | | |

| | | | | |
|---|---|---|---|---|
| Average discharge | 3.802 | 3.768 | 3.702 | 3.747 |
| voltage (V) 50 | | | | |

### <Preparation of Lithium-Ion Secondary Battery>

To each of the positive electrode active materials obtained in Examples 3 and 4 and Comparative Examples 3 and 4, acetylene black (AB) as a conductive agent, and polyvinylidene fluoride (PVDF) as a binder were blended at a weight ratio of 8:1:1 by using N-methyl-2-pyrrolidone (NMP) as a solvent to prepare a slurry. Thereafter, an aluminum foil having a thickness of 15 μm was coated with the slurry and was dried to prepare a positive electrode having a diameter of 14 φ. A coating area density was set to 4.5 mg/cm², and a volume density was set to 2.3 g/cm³. With respect to the positive electrode, a lithium metal having a thickness of 200 μm and a diameter of 16 φ was used as a counter electrode, and a polyethylene microporous film having a thickness of 20 μm and a diameter of 18 φ was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium-ion secondary battery (2032 coin-type cell) having the structure illustrated in FIG. 1 was prepared. The battery was prepared according to a known cell configuration and assembly method.

### <Charge and Discharge Test>

Each of the prepared lithium-ion secondary batteries was subjected to a charge and discharge test at a constant current at a rate of 0.05 C or 5 C (1 C: 250 mA/g) at a cutoff potential of 4.3 V to 2.5 V under a temperature condition of 25° C. to evaluate an initial discharge capacity. The charge and discharge test was started from charge. Results thereof are presented in Table 2.

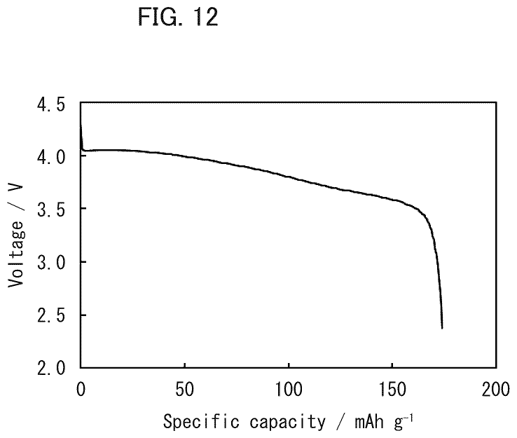

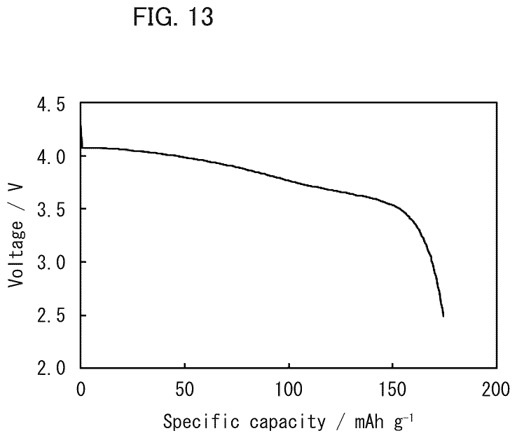

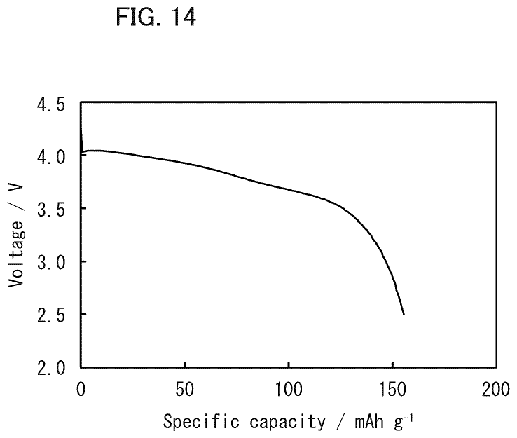

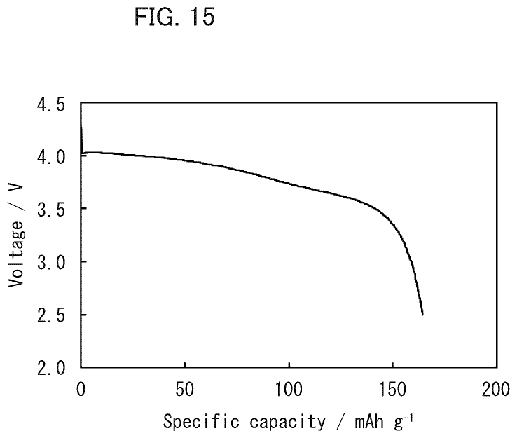

Discharge curves of the lithium-ion secondary batteries of Examples 3 and 4 and Comparative Examples 3 and 4 at 5 C are illustrated in FIGS. 12 to 15, respectively.

From the discharge curves of FIGS. 12 to 15, it was confirmed that discharge capacities and average discharge voltages of the lithium-ion secondary batteries of Examples 3 and 4 were better than those of the lithium-ion secondary batteries of Comparative Examples 3 and 4.

From the above results, it was found that the present invention could provide a lithium-ion secondary battery capable of further increasing a discharge capacity.

What is claimed is:

1. A positive electrode active material precursor for a lithium-ion secondary battery, comprising a metal composite hydroxide, wherein
the metal composite hydroxide is in a form of a particle having a core-shell structure whose surface is coated with an iron compound,
the core-shell structure is constituted by a core portion and a shell portion,
the core portion contains nickel and aluminum as metal elements,
the shell portion contains iron as a metal element,
when a composition of the core portion is represented by Ni₍₁₋ₓ₎Alₓ(OH)₂,
0.01≤x≤0.2 is satisfied,
and
a molar ratio (M₂/M₁) between a molar amount M₁ of the metal element in the core portion and a molar amount M₂ of the metal element in the shell portion satisfies
$${M}_{2} / {M}_{1} = 1 / 100 to 1 / 5.$$

2. The positive electrode active material precursor for a lithium-ion secondary battery according to claim 1, wherein the core portion does not include the same crystal structure as that of an α-type nickel hydroxide.

3. The positive electrode active material precursor for a lithium-ion secondary battery according to claim 1, wherein the shell portion contains one or more iron compounds selected from iron (II) hydroxide, iron (III) hydroxide, iron oxyhydroxide, and triiron tetraoxide.

4. The positive electrode active material precursor for a lithium-ion secondary battery according to claim 1, having an average particle size of 1 to 25 μm and a tap density of 1.30 g/mL or more.

5. The positive electrode active material precursor for a lithium-ion secondary battery according to claim 1, having a specific surface area of 2 to 50 m²/g.

6. A method for producing the positive electrode active material precursor for a lithium-ion secondary battery according to claim 1, the method comprising
a step of coating a hydroxide containing nickel and aluminum with an iron compound under an inert gas atmosphere.
